(19) United States
(12) Patent Application Publication
(10) Pub. No.: US 2001/0032530 A1
(43) Pub. Date: Oct. 25, 2001

(54) Torque extension for hex key wrench

(76) Inventor: Sil Han, Wilmette, IL (US)

Correspondence Address: Leighton K. Chong, Ostrager Chong & Flaherty (Hawaii), 841 Bishop Street, Suite 1200, Honolulu, HI, 96813, US

(21) Appl. No.: 09/843,049

(22) Filed: Apr. 25, 2001

Related U.S. Application Data
(60) Provisional application No. 60/199,740, filed on Apr. 25, 2000.

(51) Int. Cl. B25B 23/16

(52) U.S. Cl. 81/177.2

(57) ABSTRACT

A torque extension for a set of hex key wrenches of standard outer diameter sizes has at least one counter bore hole on one end with an inner diameter corresponding to the outer diameter size of at least one hex key wrench of the set. The short side of the hex key wrench can be inserted in the extension element and used for turning, while the long side of the hex key wrench is used to reach a socket-head screw in a deep recess. Preferably, each extension element has two counter bore holes on opposite ends for accommodating two hex key wrench sizes.

This patent application claims the priority benefit of U.S. Provisional Application 60/199,740 of the same inventor filed on Apr. 25, 2000.

### TECHNICAL FIELD

This invention generally relates to hex key wrenches, and particularly, to a device for torque extension of a hex key wrench.

### BACKGROUND OF INVENTION

Hex key wrenches are formed as an L-shaped piece with a short side and a long side and are provided in a set of standard hexagonal cross-section outer diameter sizes. The wrench is used like a key to fit into a hexagonal recess in a socket head cap screw to turn the screw. A common problem with the hex key wrench arises when used to drive a cap screw in a deep counter bore hole or in a deep recess.

As shown in FIG. 2, a socket head cap screw 17 is positioned in a deep counter bore hole 13 of a first part 11 to hold it to a second part 12. The hole 13 may be too deep for the short side 16 of the hex key wrench to reach the cap screw (indicated by arrows to show the gap in length). Another example is shown in FIG. 4 wherein the first and second parts 11, 12 are held together by the screw 17 recessed within a tall structure 18, such that the short side 16 of the wrench cannot reach the screw head by a gap 19. If the long side 15 of the wrench is used to reach in to turn the cap screw, the user may not be able to apply enough torque to the short side 16 of the wrench to tighten the screw sufficiently.

### SUMMARY OF INVENTION

In accordance with the invention, a device for use in combination with hex key wrenches of the type having an L-shape with a short side and a long side which are provided in a set of standard hexagonal cross-section outer diameter sizes comprises: at least one extension element of a given length having at least one counter bore hole on an end thereof, said counter bore hole having an hexagonal cross section inner diameter corresponding to the outer diameter size of at least one hex key wrench of the set, such that the short side of said one hex key wrench can be inserted and securely held in the counter bore hole of the extension element and the long side of the hex key wrench can be used to reach a socket-head screw in a deep recess while the extension element is used to apply torque leverage to the short side of the hex key wrench.

In a preferred embodiment, the hex key wrenches are provided in a plurality of outer diameter sizes and one or more extension elements are provided with the set, each having two counter bore holes on opposite ends of the respective extension elements having inner diameter sizes corresponding to two of the hex key wrench outer diameter sizes.

Other objects, features, and advantages of the present invention will be explained in the following detailed description of the invention having reference to the appended drawings.

### BRIEF DESCRIPTION OF DRAWINGS

FIG. 1 illustrates use of a torque extension for a hex key wrench in accordance with the invention to drive a socket-head screw recessed in a tall structure.

FIG. 2 illustrates a problem in the prior art with using a short side of a hex key wrench to drive a socket-head screw recessed in a tall structure.

FIG. 3 illustrates use of a torque extension for a hex key wrench to drive a socket-head screw recessed in a deep counter bore hole.

FIG. 4 illustrates a problem in the prior art with using a short side of a hex key wrench to drive a socket-head screw recessed in a deep counter bore hole.

FIG. 5 shows a preferred embodiment of a set of hex key wrenches and multiple torque extension elements.

### DETAILED DESCRIPTION OF INVENTION

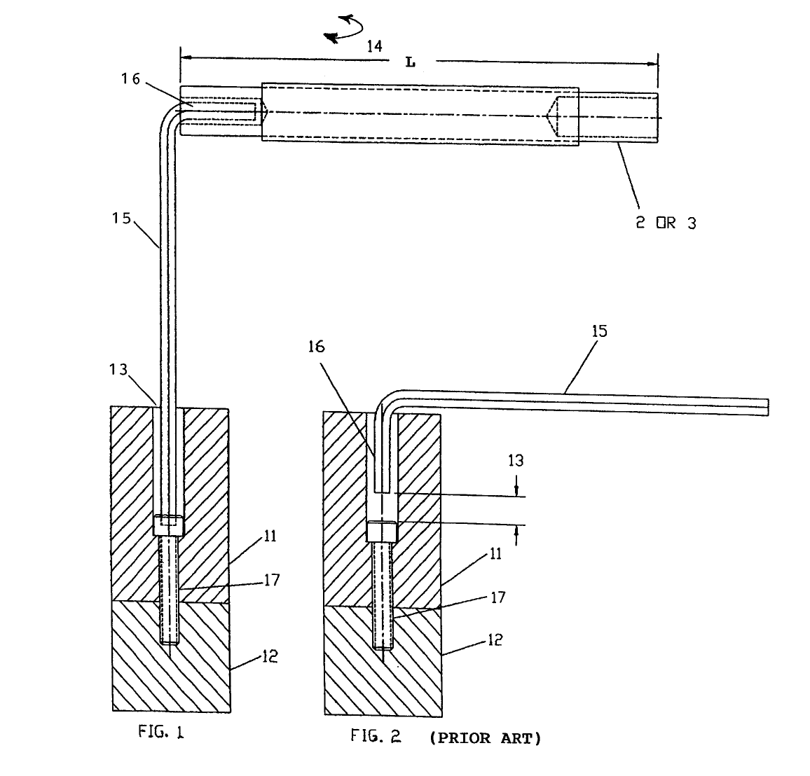

Referring to FIG. 1, the invention is used to easily drive a socket head cap screw 17 positioned in a deep counter bore hole 13 of a first part 11 to hold it to a second part 12. The hole 13 is too deep for the short side 16 of the hex key wrench to reach the cap screw. However, in the invention, the short side 16 is inserted in an extension element (2 or 3) of a given length L which has a counter bore hole on one end having a hexagonal cross section inner diameter which fits the outer diameter size of the hex key wrench. In this manner, the long side 15 of the hex key wrench can be used to reach the socket-head screw 17 recessed in the deep counter bore hole 13, while the extension element (2 or 3) is used to apply sufficient torque leverage (indicated at 14) to the short side of the hex key wrench.

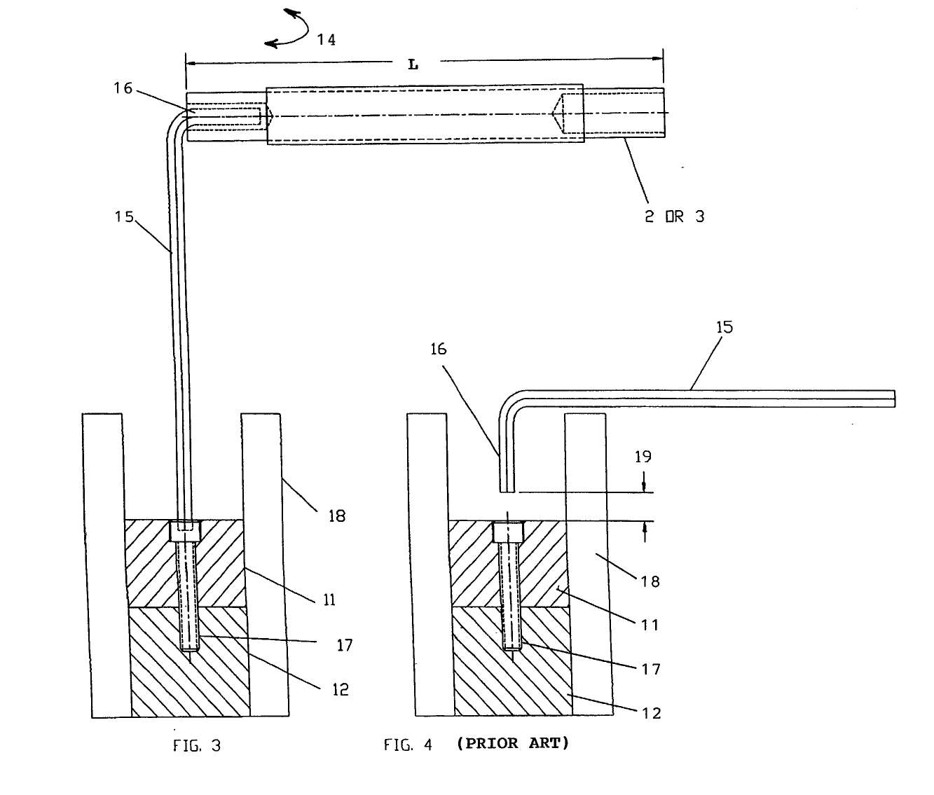

Similarly in FIG. 3, the short side 16 of the hex key wrench is inserted in the extension element (2 or 3), so that the long side 15 can be used to reach the socket-head screw 17 recessed in the tall structure 18.

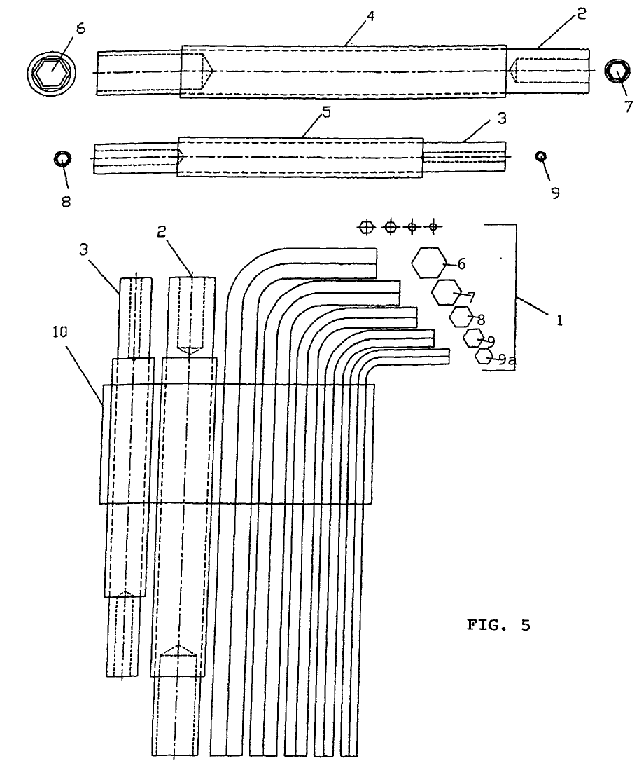

In FIG. 5, a preferred embodiment of a set of hex key wrenches and multiple extension elements is shown. The set 1 consists of a plurality (here 5) hex key wrenches 6, 7, 8, 9, and 9a, each having a respective one of a range of standard outer diameter sizes, and two extension elements 2, 3, each provided with two counter bore holes on opposite ends thereof having inner diameter sizes corresponding to two of the hex key wrench outer diameter sizes. Each extension element may be formed as a tubular metal piece with a rubber grip 4, 5 for ease of use. Each extension element can thus be used as a torque extension for two hex wrench sizes, i.e., element 2 for wrenches 6 and 7, and element 3 for wrenches 8 and 9. An extension element for the smallest hex key wrench size 9a is not used as it may apply too much force. A clasp 10 is used to hold the components of the set together.

The hex key wrench set can thus be used to drive socket-head cap screws in situations where the screws are recessed in a deep counter bore hole or within a tall structure. Since each extension element can accommodate two hex key wrench sizes, only half the number of extension elements as hex key wrenches are needed. Moreover, the extension elements can also be doubly used as socket wrenches to drive hex nuts of the corresponding sizes, using the long side 15 of the hex key wrench for leverage.

It is understood that many modifications and variations may be devised given the above description of the principles of the invention. It is intended that all such modifications and variations be considered as within the spirit and scope of this invention, as defined in the following claims.

I claim:

1. A device for use in combination with hex key wrenches of the type having an L-shape with a short side and a long side, which are provided in a set of standard hexagonal cross-section outer diameter sizes, comprising:
at least one extension element of a given length having at least one counter bore hole on an end thereof, said counter bore hole having an hexagonal cross section inner diameter corresponding to the outer diameter size of at least one hex key wrench of the set, such that the short side of said one hex key wrench can be inserted and securely held in the counter bore hole of the extension element and the long side of the hex key wrench can be used to reach a socket-head screw in a deep recess while the extension element is used to apply torque leverage to the short side of the hex key wrench.

2. A device according to claim 1, wherein the hex key wrenches are provided in a plurality of outer diameter sizes and one or more extension elements are provided with the set, each having two counter bore holes on opposite ends of the respective extension elements having inner diameter sizes corresponding to two of the hex key wrench outer diameter sizes.
